(19) United States
(12) Patent Application Publication
(10) Pub. No.: US 2008/0198571 A1
(43) Pub. Date: Aug. 21, 2008

(54) Light Guide Device

(75) Inventors: Chen-Hua Huang, Taipei (TW); Chang Hung Pan, Taipei County (TW)

Correspondence Address: BEVER HOFFMAN & HARMS, LLP;2099 Gateway Place, Suite 320, San Jose, CA, 95110, US

(73) Assignee: Lite-On Technology Corporation, Taipei (TW)

(21) Appl. No.: 11/740,841

(22) Filed: Apr. 26, 2007

(30) Foreign Application Priority Data
Feb. 16, 2007 (TW) 096106297

(51) Int. Cl. G01D 11/28; F21V 7/00

(52) U.S. Cl. 362/23; 362/341

(57) ABSTRACT

A light guide device is provided. The light guide device of the present invention includes a substrate and a plurality of patterns disposed on a surface of the substrate, wherein a material of the pattern includes an adhesive and a reflective material.

### FIELD OF THE INVENTION

The present invention relates to a light guide device, and more particularly, to a light guide device for an electronic device.

### BACKGROUND OF THE INVENTION

In the back light module, the light guide plate is used for guiding the direction of light so as to increase the display luminance and control the illumination uniformity. Please refer to FIG. 1 showing a schematic view of the light guide device according to the prior art. As shown in FIG. 1, the light source 11 is disposed on the side of the light guide plate 12, and the lateral light emitted from the light source enters into the light guide plate 12, the light in the light guide plate 12 is repeatedly reflected, and progresses toward a direction opposite to the direction of the incident light. When the light is reflected, a part of the light is scattered from the pattern 13 on the light guide plate, so as to emit from the surface of the light guide plate 12 as the illumination source, wherein the pattern 13 is formed by printing or etching.

Please refer to FIG. 2 showing a schematic view of the light guide device applied in a mobile phone according to the prior art. When the light guide plate is applied in the keypad of a portable electronic device such as a mobile phone, the adhering layer 23 is attached on the side with the pattern 22 of the light guide plate 21 for adhering to the dome sheet 24. The dome sheet 24 has a surface 241 with the adhesive, so as to adhere the metal dome 25 to be connected to the printed circuit board (PCB) 26. It is time-consuming for the connection of the conventional adhering layer and the dome sheet, and furthermore the conventional mobile phone cannot be thinned owing to the numerous layers thereof.

Accordingly, in order to overcome the above-mentioned drawbacks, the present invention provides a light guide device for simplifying the fabrication process and reducing the cost thereof. The light guide device of the present invention can be used in any illuminated keyboard or keypad of an electronic device such as a mobile phone, a personal digital assistant (PDA), a global positioning system (GPS), a digital video (DV), a portable digital versatile disc (portable DVD), etc. Also, the light guide device of the present invention can be used in a notebook (known as a Note PC). The electronic device having the light guide device of the present invention not only has a reduced cost, but also a thinner size and a lighter weight.

### SUMMARY OF THE INVENTION

It is an aspect of the present invention to provide a light guide device having a light guide plate, wherein the light guide plate of the present invention has patterns thereon, and the material of the patterns in the present invention is different from that of the prior art. Using the light guide device of the present invention, the fabrication of the electronic device is simplified, and therefore the light guide device can be used more widely.

In accordance with the aspect of the present invention, the present invention provides a light guide device, including a substrate and a plurality of patterns disposed on a surface of the substrate, wherein a material of the pattern includes an adhesive and a reflective material.

Preferably, the substrate is a light guide material.

Preferably, the light guide material is one of a plate and a film.

Preferably, the plate is made of polymethylmethacrylate (PMMA).

Preferably, the film is made of one of polycarbonate (PC) and polyethylene terephthalate (PET).

Preferably, the adhesive is a glue.

Preferably, the reflective material is one of SiO₂ and TiO₂.

Preferably, the patterns disposed on the surface of the substrate are formed by printing.

It is another aspect of the present invention to provide a keypad device for an illuminated keyboard, a portable electronic device or a notebook, wherein the material of the patterns used in the keypad of the present invention is different from that used in the prior art. Accordingly, the keyboard, the portable electronic device and the notebook using the keypad device of the present invention have simplified fabrication processes thereof, the reduced fabrication cost, much thinner size and much lighter weight.

In accordance with the aspect of the present invention, the present invention provides a keypad device for a keyboard, a portable electronic device and a notebook, wherein the keypad device includes a light guide plate and a plurality of patterns formed on a surface of the light guide plate by printing, in which a material of the pattern includes an adhesive and a reflective material.

Preferably, the light guide plate is one of a plate and a film.

Preferably, the plate is made of polymethylmethacrylate (PMMA).

Preferably, the film is one of polycarbonate (PC) and polyethylene terephthalate (PET).

Preferably, the adhesive is a glue.

Preferably, the reflective material is one of SiO₂ and TiO₂.

It is another aspect of the present invention to provide a keypad device for a keyboard, a portable electronic device or a notebook, wherein the material of the patterns used in the keypad of the present invention is different from that used in the prior art. Accordingly, the keyboard, the portable electronic device and the notebook using the keypad device of the present invention have simplified fabrication processes, the reduced fabrication cost, much thinner size and much lighter weight.

In accordance with the aspect of the present invention, the present invention provides a keypad device for a keyboard, a portable electronic device and a notebook. The keypad device of the present invention includes a light guide plate, a plurality of patterns formed on a surface of the light guide plate by printing and a plurality of metal domes directly connected to the patterns, wherein a material of the pattern includes an adhesive and a reflective material.

Preferably, the light guide plate is one of a plate and a film.

Preferably, the plate is made of polymethylmethacrylate (PMMA).

Preferably, the film is one of polycarbonate (PC) and polyethylene terephthalate (PET).

Preferably, the adhesive is a glue.

Preferably, the reflective material is one of SiO₂ and TiO₂.

The foregoing and other features and advantages of the present invention will be more clearly understood through the following descriptions with reference to the drawings, wherein:

### BRIEF DESCRIPTION OF THE DRAWINGS

FIG. 1 is a schematic view showing the light guide device according to the prior art.

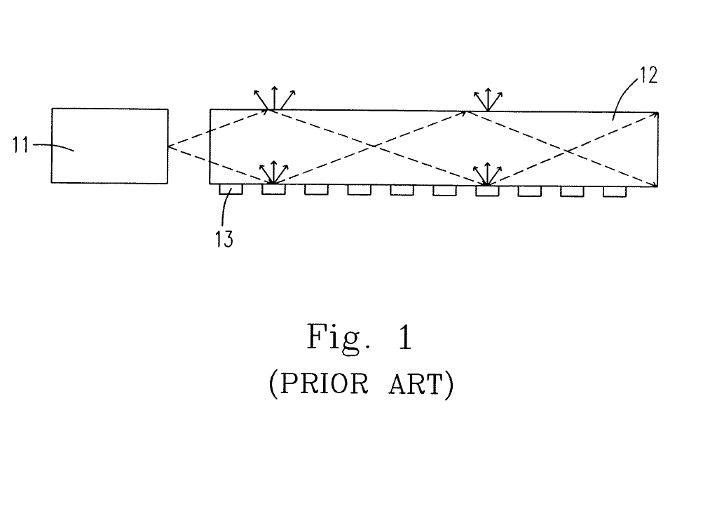

FIG. 2 is a schematic view showing the light guide device applied in the mobile phone according to the prior art.

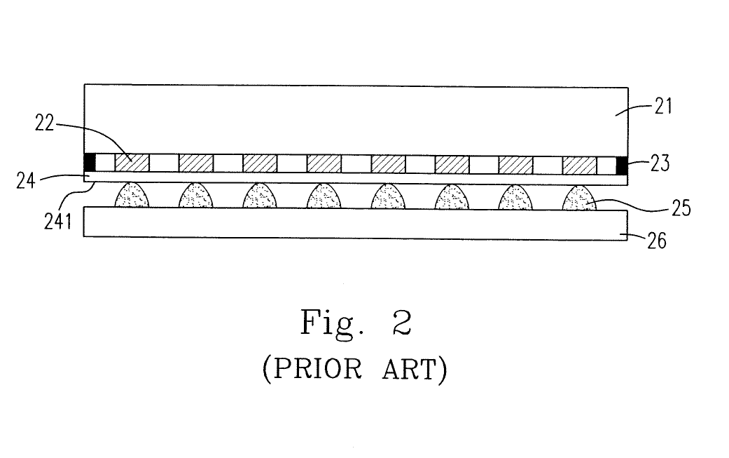

FIG. 3 is a schematic view showing the light guide device according to the first preferred embodiment of the present invention.

FIG. 4 is a schematic view showing the keypad device applied in the mobile phone according to the second preferred embodiment of the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

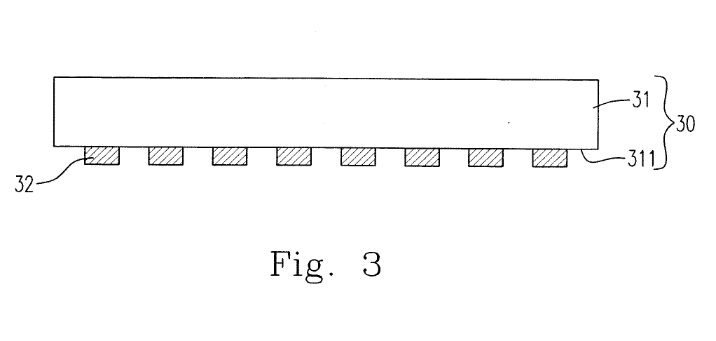

Please refer to FIG. 3, which is a schematic view showing the light guide device according to the first preferred embodiment of the present invention.

The light guide device 30 of the present invention includes a substrate 31 and a plurality of patterns 32, wherein the patterns 32 are formed on the surface 311 of the substrate 31 by printing, and the material of the pattern 32 includes an adhesive and a reflective material.

In this embodiment, the substrate 31 may be a light guide material, which can be a plate or a film. The plate is made of polymethylmethacrylate (PMMA), and the film is made of polycarbonate (PC) or polyethylene terephthalate (PET). Certainly, the light guide plate known by one skilled in the art can be used as the light guide material for the substrate 31. The adhesive may be a glue, and the reflective material may be SiO₂ or TiO₂. Certainly, the adhesive and the reflective material known by one skilled in the art can be used in the present invention.

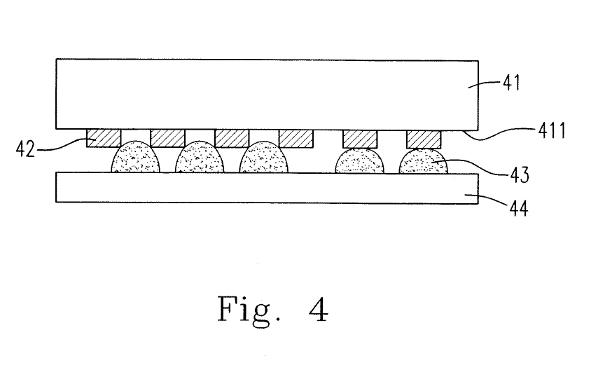

Please refer to FIG. 4 showing a schematic view of the keypad device applied in the mobile phone according to the second preferred embodiment of the present invention.

The keypad device of the present invention includes a light guide plate 41 and a plurality of patterns 42 formed on a surface 411 of the light guide plate 41 by printing, in which the material of the pattern 42 includes an adhesive and a reflective material. Since the patterns 42 have the adhesive, plural metal domes 43 are directly connected to the patterns 42 via the adhesive, and then the metal domes 43 are connected to the printed circuit board (PCB) 44. The adhesive may be a glue, and the reflective material may be SiO₂ or TiO₂. Similarly, the adhesive and the reflective material known by one skilled in the art can be used in the present invention.

In the present invention, the patterns are formed by the mixture of the adhesive and the reflective material for scattering the light, and furthermore the patterns have the adhesive, so that while the light guide device of the present invention is applied in an electronic device, the patterns are used for directly adhering to the metal domes so as to be further connected to the printed circuit board. Accordingly, the adhering layer and the dome sheet in the conventional fabrication process can be omitted in the present invention.

Accordingly, in contrast with the mobile phone fabricated in the prior art, the mobile phone having the light guide device of the present invention has a simplified fabrication process thereof. Furthermore, the mobile phone having the light guide device of the present invention has a thinner size without the dome sheet since the patterns on the light guide plate have the adhesive.

The light guide device of the present invention may be applied in any illuminated keyboard and keypad device for an electronic device such as a personal digital assistant (PDA), a global positioning system (GPS), a digital video (DV), a portable digital versatile disc, a notebook, etc.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. According, the invention is not limited by the disclosure, but instead its scope is to be determined entirely by reference to the following claims.

What is claimed is:

1. A light guide device, comprising:
a substrate; and
a plurality of patterns disposed on a surface of the substrate,
wherein a material of the pattern includes an adhesive and a reflective material.

2. The light guide device according to claim 1, wherein the substrate is a light guide material.

3. The light guide device according to claim 2, wherein the light guide material is one of a plate and a film.

4. The light guide device according to claim 3, wherein the plate is made of polymethylmethacrylate.

5. The light guide device according to claim 3, wherein the film is made of one of polycarbonate and polyethylene terephthalate.

6. The light guide device according to claim 1, wherein the adhesive is a glue.

7. The light guide device according to claim 1, wherein the reflective material is one of SiO₂ and TiO₂.

8. The light guide device according to claim 1, wherein the patterns disposed on the surface of the substrate are formed by printing.

9. A keypad device for an electronic device, comprising:
a light guide plate; and
a plurality of patterns formed on a surface of the light guide plate by printing,
wherein a material of the pattern includes an adhesive and a reflective material.

10. The keypad device according to claim 9, wherein the light guide plate is one of a plate and a film.

11. The keypad device according to claim 10, wherein the plate is made of polymethylmethacrylate.

12. The keypad device according to claim 10, wherein the film is one of polycarbonate and polyethylene terephthalate.

13. The keypad device according to claim 9, wherein the adhesive is a glue.

14. The keypad device according to claim 9, wherein the reflective material is one of SiO₂ and TiO₂.

15. A keypad device for an electronic device, comprising:
a light guide plate;
a plurality of patterns formed on a surface of the light guide plate by printing; and
a plurality of metal domes directly connected to the patterns,
wherein a material of the pattern includes an adhesive and a reflective material.

16. The keypad device according to claim 15, wherein the light guide plate is one of a plate and a film.

17. The keypad device according to claim 16, wherein the plate is made of polymethylmethacrylate.

18. The keypad device according to claim 16, wherein the film is one of polycarbonate and polyethylene terephthalate.

19. The keypad device according to claim 15, wherein the adhesive is a glue.

20. The keypad device according to claim 15, wherein the reflective material is one of SiO₂ and TiO₂.
